(19) United States
(12) Patent Application Publication
(10) Pub. No.: US 2006/0061481 A1
(43) Pub. Date: Mar. 23, 2006

(54) Receptacle locator

(76) Inventors: William M. Kurple, St. Charles, MO (US); C. Michael Jacobi, Middlebury, CT (US)

Correspondence Address: Robert L. Villhard;Thompson Coburn LLP, One US Bank Plaza, Suite 3500, St. Louis, MO, 63101-9928, US

(21) Appl. No.: 10/948,583

(22) Filed: Sep. 23, 2004

(51) Int. Cl. G08B 21/00; G08B 1/08

(52) U.S. Cl. 340/686.1; 340/539.23; 340/539.26

(57) ABSTRACT

Methods and apparatus for positively positioning receptacle at a pre-selected location. In a preferred embodiment a system for positioning a receptacle is provided. The system includes a transmitter, a receiver, and an indicator. The transmitter may be on the receptacle and transmits a signal from the current receptacle position. The receiver receives the signal and using the received signal, causes the indicator to indicate whether the receptacle is at the pre-selected position. In other preferred embodiments, the receptacle includes a power supply for the power consuming components on the receptacle. In another preferred embodiment, the transmitter is at the pre-selected position and the receiver is on the receptacle. Methods are also provided which include transmitting and receiving a signal from the current position of the receptacle. From the signal strength it is determined whether the receptacle is at the pre-selected position.

### BACKGROUND OF THE INVENTION

1. Field of the Invention

This invention relates generally to residential and receptacles. More particularly, the present invention pertains to a re-positionable receptacle that is modified with an apparatus that positively locates the receptacle to facilitate emptying the receptacle by a vehicle having articulating arms.

2. Description of the Related Art

Receptacles are commonly employed to contain raw and purified materials, piece parts, intermediate products, finished products, scrap, and refuse. Because the receptacles tend to fill quickly in manufacturing, residential, and other environments the receptacles typically rest on castors, wheels, or other translation aids to allow them to be easily moved about by the users of the receptacles. Additionally, the receptacles typically include lugs, channels, or other handling aids on their exteriors that enable mechanisms to handle the receptacle, in particular, for lifting and emptying the receptacle. For instance, many commercial trash receptacles have a pair of hollow channels extending along the sides of the receptacle through which the articulating arms of a refuse truck slide to engage the receptacle. Thereafter, the arms lift the receptacle over a bin of the truck. The arms then rotate the receptacle to empty the contents into the bin.

Since the receptacles are movable, the truck operator frequently finds the receptacles out of the proper lifting position. Thus, the operator must stop the truck, engage the brake, dismount, move the receptacle to the proper position, and climb back into the truck before he can operate the articulating arms to empty the receptacle. A task that should have taken no more than half a minute may therefore take much more time and effort, resulting in an increase in the labor and expense associated with performing the task. If the misalignment occurs at a high percentage of the truck operator's stops, the resulting inefficiencies multiply rapidly. Worse still, in situations where the receptacle is employed in an automated, or semi-automated environment (e.g. the receptacle is a source of raw materials feeding an automated line), the misalignment may result in waste, spillage, or a shortage of the feed product. Thus, a need exists to ensure that receptacles are properly aligned with the lifting apparatus.

### SUMMARY OF THE INVENTION

It is in view of the above problems that the present invention was developed. The invention includes methods and apparatus for quickly and accurately positioning a receptacle at a positive location at which the user desires to handle the receptacle.

In a first preferred embodiment a system is provided for accurately positioning a receptacle at a positive location. The system includes a small inexpensive radio frequency tag or transponder in place at a location (preferably in an enclosure located below grade) where the receptacle is to be located. The receptacle has a sensor that beeps or blinks to indicate whether the receptacle is at the positive location. The vehicle, with the articulating arms used to empty the receptacle, would also have a sensor so that emptying of the receptacle could be recorded for billing purposes. In another preferred embodiment, the receptacle has a sensor, a power source (e.g. a battery), an indicator (e.g. a beep sequence or a needle gauge), and a memory storage device.

In a second preferred embodiment a receptacle is provided. The receptacle is to be maintained at a desired location that is marked by a small, inexpensive radio frequency identification detection (RFID) tag. The receptacle includes a body, an RF (radio frequency) transceiver, an indicator, and a power supply for the power consuming components on the receptacle. The transceiver is on the receptacle body, transmits an RF signal in the general area of the RFID tag, and receives a signal that is generated by the RF tag in response to the transmitted signal. The indicator is also on the receptacle body and communicates with the transceiver. If the strength of the responsive signal is above a threshold level, the indicator indicates that the receptacle is approximately at the position of the RF tag used for locating the receptacle.

Additionally, the transceiver may be part of an RFID tag reader located on the receptacle. A computerized memory storage device may be on the receptacle for storing tracking information regarding the receptacle. Further, the memory may communicate the tracking information to the transceiver. The receptacle may also include a motion sensor communicating with the indicator such that the indicator only indicates whether the receptacle is at the pre-selected location of the tag when the receptacle is moving. Preferably, a timer also communicates with the indicator to turn off the indicator a pre-selected time after the receptacle stops moving. Both the motion sensor and timer serve to reduce power consumption of the components located on the receptacle thereby extending battery life for battery operated embodiments.

In yet another preferred embodiment, a radio tag at the pre-selected position may include a transmitter that transmits a pulse at a periodic rate. In the current embodiment, the pre-selected position does not include receiver. In such an embodiment, the receptacle includes a receiver that detects the pulse and indicates the position of the receptacle accordingly. The receptacle, though, does not include a transmitter in the current embodiment.

In still another preferred embodiment, the invention provides a receptacle with a body and a circuit. Again, the receptacle is to be maintained at a desired location marked by a radio tag. The receptacle circuit includes a transmitter, a receiver, and an indicator. The receiver receives a signal (from the radio tag at the pre-selected position for the receptacle) that is responsive to a signal from the transmitter. From this responsive signal, the indicator indicates whether the receptacle is approximately at the pre-selected position.

In another preferred embodiment, the present invention provides a station for handling at least one receptacle. The station includes a pre-selected position for the receptacle and a radio tag or other equivalent transmitter at the pre-selected position. The transmitter transmits a signal that the receptacle receiver responds to by indicating whether the receptacle is approximately at the pre-selected position. An enclosure may also be provided at the fixed position (preferably below grade) to house the transmitter. In the alternative, the transmitter may be attached to a surface at the pre-selected position or elevated above the pre-selected position. Additionally, an area may be provided for a vehicle to align with the receptacle while the receptacle is at the pre-selected position. Of course, the station may include pre-selected positions for additional receptacles along with additional transmitters to allow the receptacle to be positioned at other locations.

A system for positioning a receptacle is provided by yet another preferred embodiment. The system includes a transmitter, a receiver, and an indicator. The transmitter is provided either on the receptacle or at the pre-selected position, while the receiver and indicator are on the other of the receptacle or the pre-selected position. The indicator indicates whether the signal received from the transmitter, by the receiver, is indicative of the receptacle being at the pre-selected position.

The present invention also provides methods for handling receptacles. In a preferred embodiment, a method includes pre-selecting a position at which to locate the receptacle. A signal is transmitted from a transmitter on the receptacle and received by a receiver at the pre-selected position. The receiver then determines whether the received signal strength indicates that the receptacle is approximately at the pre-selected position. Additionally, the determination of whether the receptacle is at the pre-selected position may occur only when a motion sensor indicates that the receptacle is moving.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a receptacle station constructed in accordance with a preferred embodiment of the present invention;

FIG. 2 illustrates a receptacle positioning system in accordance with a preferred embodiment of the present invention;

FIG. 3 illustrates a method in accordance with a preferred embodiment of the present invention; and

FIG. 4 illustrates yet another receptacle positioning system constructed in accordance with a preferred embodiment of the present system.

### DETAILED DESCRIPTION OF THE PREFERRED EMBODIMENTS

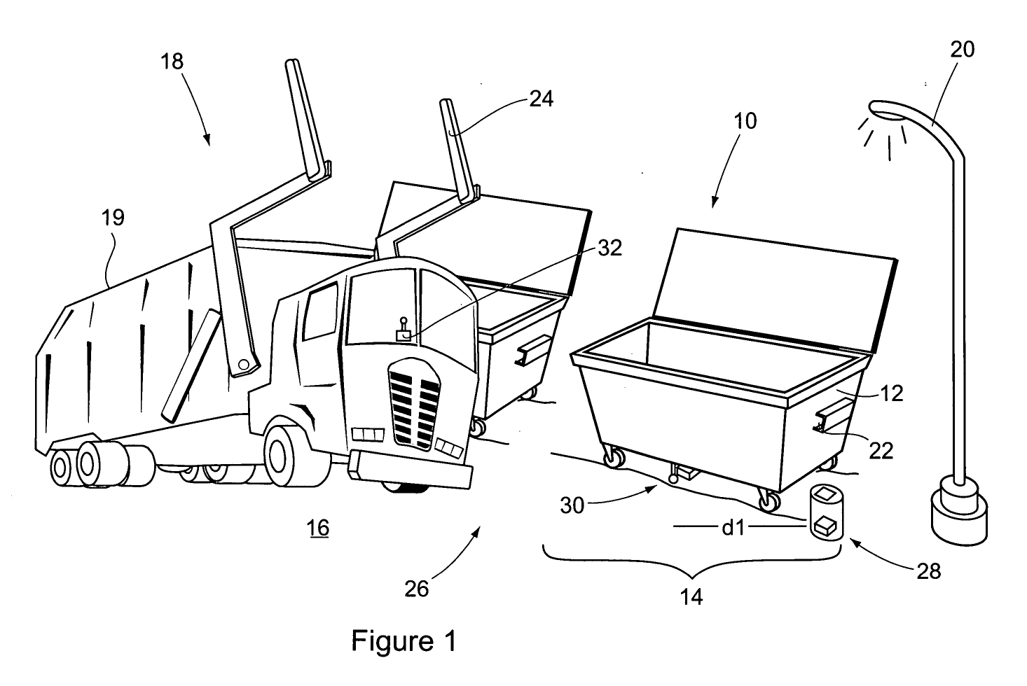

Referring to the accompanying drawings in which like reference numbers indicate like elements, FIG. 1 illustrates a receptacle station constructed in accordance with a preferred embodiment of the present invention.

As illustrated in FIG. 1, a typical receptacle station 10 includes space for numerous receptacles 12, a position 14 for each of the receptacles, an area 16 for a truck 18 (or other device) to align with each of the receptacles 12, and structures 20 and other obstructions for which it is desirable to avoid striking them with the receptacles 12 while handling the receptacles 12. In addition, the receptacles include handling aids 22 on their exteriors while the truck 18 includes a mechanism 24 for handling the receptacles 12. An exemplary handling mechanism 24 is shown as a pair of hydraulically operated arms on the refuse truck 18.

During nominal operations, a truck operator aligns the truck 18 with the receptacle 12 so that the lifting arms 24 can engage the lifting aids 22. Next, the operator advances the truck 18 until the lifting arms 24 slide into the lifting aids 22. Then the operator causes the lifting arms 24 to lift and rotate the receptacle 12 so as to empty the contents of the receptacle 12 into the compactor 19 of the refuse truck 18. Afterward, the operator then uses the lifting arms 24 to set the receptacle 12 back in its original position 14. If the receptacle 12 is not in its nominal position when the operator arrives, the operator may not be able to align the truck 18 with the receptacle 12. Or if the operator does succeed in aligning the truck 18 with the out of position receptacle 12, the receptacle 12 could strike the obstacle 20 as it is lifted.

FIG. 1 also illustrates a system 26 for use in positively positioning a receptacle at a location that has been pre-selected for the receptacle. In a preferred embodiment the system 26 generally includes three sub-assemblies 28, 30, and 32. Sub-assembly 28 is located at the pre-selected position for the receptacle 12. Sub-assembly 30 is located on the receptacle 12 itself. The third sub-assembly 32 is located on the truck 18 and will be discussed in more detail subsequently. Together, the three sub-assemblies 28, 30, and 32 cooperate to provide the user of the receptacle 12, the operator of the truck 18, and others an indication of whether the receptacle 12 is at the pre-selected receptacle location. One of the sub-assemblies 28 or 30 includes an RF transmitter and the other includes a receiver.

To determine whether the receptacle 12 is at the pre-selected position the sub-assemblies 28, 30, and 32 cooperate as follows. The subassembly 28 or 30 that includes the transmitter transmits a signal to the receiver. Of course, the signal varies inversely with the distance it travels from the transmitter. In turn, the receiver senses the strength of the signal and, using the sensed signal strength, determines whether the transmitter is within a pre-selected distance. If so, then the receptacle 12 is judged to be at the pre-selected position for it. A blinking light, audible tone, or an equivalent indication is generated to indicate that the receptacle 12 is at the pre-selected position. If not, then the receptacle 12 is judged to be too far from the pre-selected position and the indication provided by the indicator is modified to indicated that the receptacle 12 needs to be re-positioned to the pre-selected position. Thus, the system 26 allows the user of the receptacle 12 to quickly and efficiently position the receptacle 12 at the pre-selected position.

Turning now to the sub-assembly 32 that is located on the truck 18, the sub-assembly 32 communicates with the other sub-assemblies 28 and 30 to read tracking data pertinent to the receptacle 12 from the sub-assemblies 28 and 30. For example, the tracking data can include a receptacle identification, a receptacle-position identification, and current and historic information regarding the servicing of the station 14 and the receptacles 12 at the station 14. Thus, the operator of the truck 18 may more accurately bill the user of the receptacles 12 for emptying the receptacles 12. Otherwise, as with previous systems, the operator merely bills the user periodically with no basis in how many times the receptacles 12 have actually been emptied. The present invention therefore eliminates over-billing for infrequently emptied receptacles 12 and under-billing for frequently emptied receptacles 12. As a result the system 26 benefits both truck operators and receptacle users. Similarly, the truck sub-assembly 32 can read the receptacle identification from the receptacle sub-assembly 30, compare it to an acceptable identification read from the station receptacle 28 and verify that the particular receptacle 12 belongs at the particular station 14. If not, the sub-assembly 32 can alert the truck 18 operator who may then refuse to empty the receptacle 12 as circumstances suggest. All of the data read from the sub-assemblies 28 and 32 by the truck sub-assembly 30 can then be downloaded at a central location for billing and trending analysis.

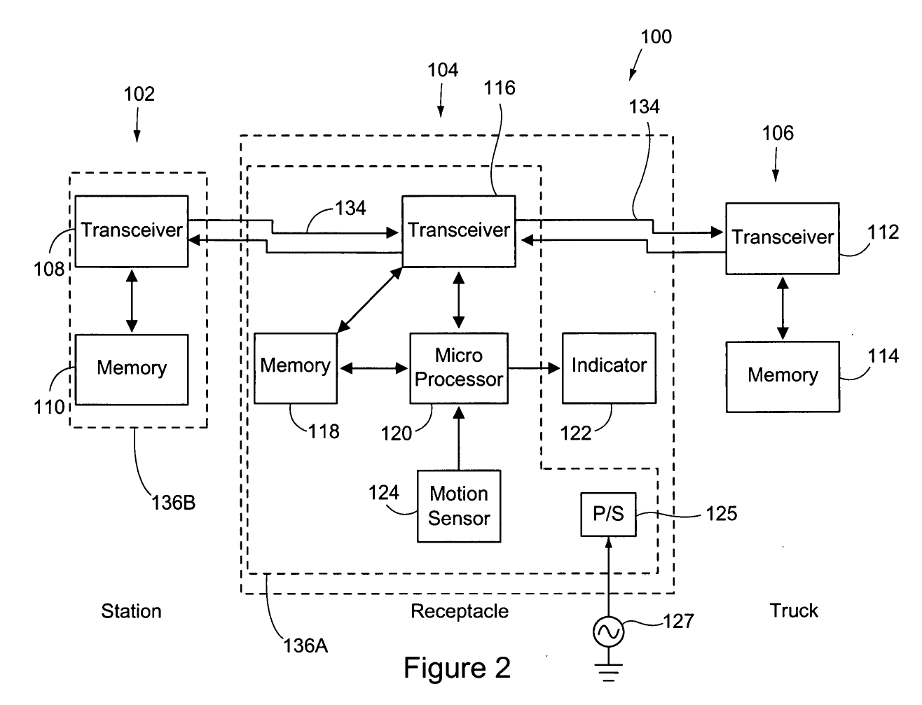

Turning now to FIG. 2, a receptacle position verification system 100 provided by a preferred embodiment of the present invention is shown. The system 100 (shown in block diagram form) generally includes three subsystems. One subsystem 102 is located at a pre-selected position for the receptacle within an area that may be deemed to be a receptacle handling station or area. Another subsystem 104 is located on the receptacle. The third subsystem 106 is located in any location convenient for reading the tracking information from the other subsystems 102 and 104, such as on a refuse truck. Thus, the subsystems 102, 104, and 106 of FIG. 2 generally correspond to the sub-assemblies 28, 30, and 32 of FIG. 1.

The receptacle station subsystem 102 includes a transceiver 108 that is in communication with a memory 110. Similarly, the refuse truck subsystem 106 includes a transceiver 112 and a memory 114. The receptacle subsystem 104 includes additional components including a transceiver 116, a memory 118, a programmable device (or other circuit) 120, an indicator 122, and a motion sensor 124 interconnected as shown. The motion sensor 124 acts as an input to the circuit 120 while the indicator 122 acts as an output of the circuit 120. Of course, each of these subsystems 102, 104, and 106 typically includes, or is connected to a power supply 125 (shown for only the receptacle subsystem 104) to power the power consuming components of the particular subsystem. The subsystems 102 and 104 will typically be separated by the distance d1 (see FIG. 1) between the RF transceiver 108 and the RF transceiver 116 that are, respectively, at the pre-selected position and on the receptacle. Because of the distance d1 and the mobile nature of the receptacle, the subsystems 102 and 104 communicate with each other via electromagnetic (e.g. radio frequency or RF) communication paths 134. Also, any two of the subsystems 102, 104, and 106 may communicate directly with each other (e.g. subsystems 102 and 106) without the need for the other subsystem (e.g. subsystem 104) to relay information between the two.

In operation, the station transceiver 108 transmits a signal from the pre-selected position. Of course, the strength of the signal varies inversely with distance d1. Thus, when the receptacle transceiver 116 receives the signal, the circuit 120 can determine the distance d1 from the signal strength. If the distance d1 is above a pre-selected threshold distance then the circuit 120 causes the indicator 122 to indicate (via for example an audible or visual pattern) that the receptacle is not at its pre-selected position. On the other hand, if the distance d1 is determined to be less than the threshold distance then the receptacle is judged to be sufficiently close to the pre-selected position that no additional re-positioning is necessary. Therefore, the circuit 120 causes the indicator 122 to indicate (via a second pattern) that the receptacle is at its pre-selected position. Of course, the indication provided by the indicator 122 may vary with the distance d1 (e.g. the indicator 122 is an analog device such as a needle gauge or an equivalent) so that the user can also judge the magnitude of the distance d1. The circuit 120, though, does not have to determine the distance d1. Rather, a preferred, and simpler, embodiment includes a circuit 120 that senses the strength of the signal and compares the strength directly to a threshold signal strength. If the strength is sufficient, the circuit 120 causes the indicator 122 to indicate that the receptacle is within an acceptable distance from the pre-selected position. Of course, the circuit 120 may include an input for adjusting the thresholds and may also include power regulators to maintain constant signal strength despite variations in the power supplied via the power supply 125.

In one preferred embodiment, a simplified system 100 includes the following components a transmitter 108 at the preselected position, a receiver 116 on the receptacle, and an indicator 122 communicating with the receiver to indicate whether the receptacle is at the preselected position. In an alternative embodiment, the transmitter is on the receptacle and the receiver is at the preselected position.

The receptacle subsystem 104 can also determine whether the receptacle is being moved via the motion sensor 124. Embodiments that include the motion sensor 124 may save power by indicating whether the receptacle is at the pre-selected position only when the receptacle is moving (i.e. when a user is attempting to position the receptacle). Otherwise, the subsystem 104 can remain dormant and in a low, or no, power state until needed. For such low power embodiments, the circuit 120 first determines whether the receptacle is moving (e.g. being re-positioned) by checking the input from the motion sensor 124. If the receptacle is not moving, the circuit 120 leaves the indicator in an “off” condition regardless of the presence, or strength, of a signal from the station transceiver 108. If the motion sensor 124 indicates that the receptacle is moving, then the circuit 120 checks the signal strength, as previously described. Depending on the comparison between the strength and the threshold strength, the circuit 120 causes the indicator 122 to indicate whether the receptacle is at the pre-selected position. Once the sensed motion stops, the circuit 120 may wait a pre-selected time before returning the indicator 122 to its off condition. Thus, the system 100 allows a receptacle user to know, by observing the indicator 122, whether the receptacle has reached its pre-selected position or whether additional re-positioning is desirable.

In still another preferred embodiment, the power supply 125 for the receptacle subsystem 104 draws power from a generator 127 or other source of power. The generator 127 may be a solar power supply, a battery, a connection to an industrial or residential power supply that is associated with the receptacle station, or an equivalent of any of these power sources. For instance, the generator 127 may be a mechanical generator driven by a wheel that is positioned under the receptacle in a manner such that the wheel rolls over the ground as the receptacle moves. Thus, the generator 127 supplies power at those times when the receptacle user is moving the receptacle and, accordingly, is most interested in knowing whether the receptacle is properly positioned. Mechanical generators 127 can therefore also be used as the motion sensor 124 since the presence of power at the generator 127 indicates that the receptacle is moving. A capacitor can also be supplied in the power supply 125 to continue powering the receptacle subsystem 104 for a pre-selected time after the receptacle stops moving.

In another preferred embodiment, the subsystem 104 is incorporated into a programmable RFID (radio frequency identification) chip. RFID chips may be glued, or otherwise affixed to objects to manage an inventory of such objects (e.g. products on a store shelf). RFID chips, or tags, are constructed to receive an RF signal and, in response, transmit a code unique to the particular tag. The tags come in many varieties including active, passive, read only, read/write, and (non) programmable tags. Active RFID tags require a power supply whereas passive RFID tags inductively derive the power they use from the RF signals they receive. Thus, passive RFID tags provide a low power consumption device while the active RFID tags provide a greater range over which the return signals can be detected. RFID tags typically include an antenna coil around the actual chip, although they can be coupled to an external antenna to increase their range. The most common RFID tags only transmit information (e.g. their identification), although increasingly writable tags are available on which information can be written to a memory. In turn, the RFID tag can subsequently transmit information from the memory. RFID tags are also available that incorporate programmable devices, and even sensors, so that the tags can be configured to process inputs, produce outputs, and gather and store information in their memories.

RFID tags are typically used in conjunction with RFID tag readers, or scanners, although they can be configured to communicate with one another. The RFID readers transmit a signal that the tags respond to with a transmission of their own. The responsive transmission can include any information stored or sensed by the tag. RFID readers can, of course, also write information to the tags. Thus, RFID tags and readers may be configured to function as the subsystems 102, 104, and 106. Systems 100 created with RFID technology, therefore, offer the advantages of being small, readily available, and flexible in their use.

As an example of the flexibility provided by RFID technology, the programmable circuit 120 of RFID tag 136A may be adapted to update a counter stored in the receptacle memory 118 each time the motion sensor 124 senses the receptacle being lifted, rotated, or otherwise emptied. Thus, the receptacle memory 118 can maintain a count of how many times the receptacle has been emptied. Similarly, the station subsystem 102 also includes an RFID tag 136B including the station transceiver 108 and the station memory 110. In a preferred embodiment, the tag 136B at the pre-selected position is a passive RFID tag. The station transceiver 108 may be adapted to receive (from the receptacle subsystem 104) a transmission including the count of how many times the receptacle has been emptied that is stored in the receptacle memory 118. From the station memory 110, the user may then retrieve the count and use it to verify the charges that have accrued on the user's receptacle servicing bills. Similarly, the truck subsystem 106 of FIG. 2 may include an RFID tag “reader” 112 to read tracking data from the receptacle RFID tag 104. FIG. 1 illustrated by Figure illustrates another example of the advantages of using RFID tag technology in that the sub-assembly 28 (or the station sub-system 102) can include an RFID tag situated in the ground at the position pre-selected for the receptacle. In the alternative, the RFID tag could be elevated above the ground to aid the user in positioning the receptacle where debris (e.g. snow) might be covering the ground. In such applications, the tag on the receptacle could be elevated also to correspond to the elevated station tag. An optional enclosure can be provided so that the RFID tag is protected from the environment and mechanical abuse. Though, the enclosure for the RFID tag is not necessary for the practice of the invention since RFID tags are available in rugged pre-packaged forms.

Of course, where each receptacle of a plurality of receptacles includes a subsystem 104, the memory 118 of each receptacle may also include a receptacle identification number whether or not RFID tags are incorporated in any of the subsystems 102, 104, or 106. When the receptacle transceiver 116 transmits the tracking data stored in the memory receptacle 118, it may also transmit the receptacle ID. In this manner, the other subsystems 102 and 106 know both the number of times a receptacle is emptied and the identity of the receptacle.

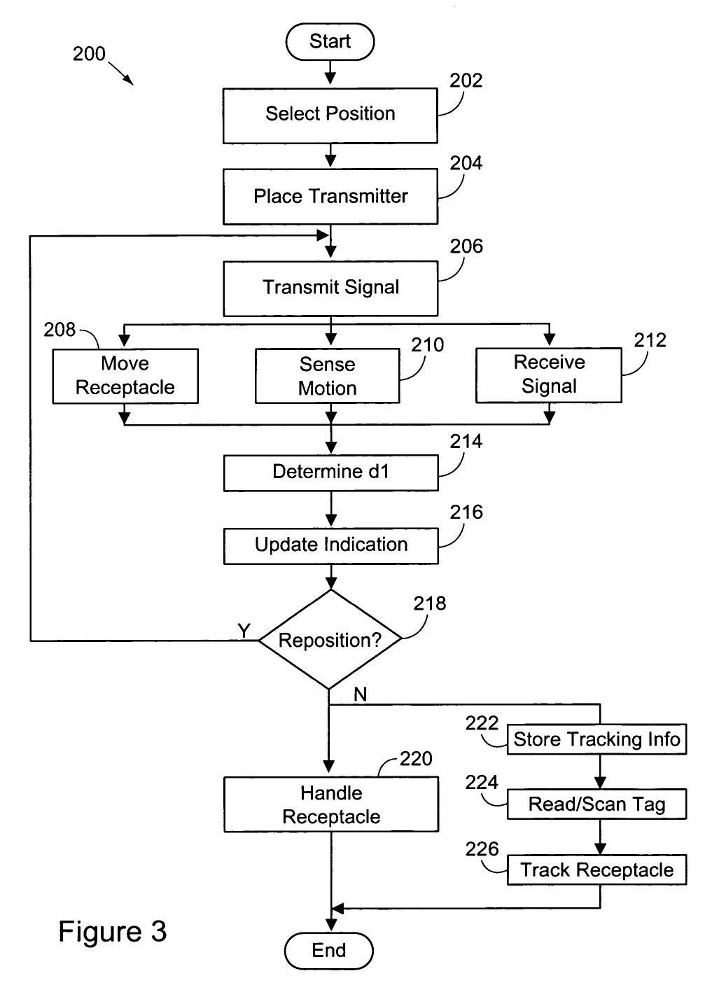

Turning now to FIG. 3, a method in accordance with the principles of the present invention is illustrated. It should be noted that the preferred methods discussed below are merely exemplary and the specific order of operations discussed does not limit the scope of the present invention. Rather, other combinations of operations and other methods in which the exemplary operations are performed in different orders are included in the scope of the present invention. The method 200 (of FIG. 3) includes selecting a position for a receptacle as in operation 202. If power has not already been applied to the power consuming components of the system, power can be applied at this time. A transmitter is placed at the pre-selected position or station in operation 202 and transmissions are started in operation 206. At some time prior to the emptying of the receptacle, the user or operator moves the receptacle in an attempt to position it at the pre-selected position. See step 208. As the user begins moving the receptacle the motion of the receptacle is sensed by the receptacle motion sensor 124 in operation 210. Generally in parallel with operations 208 and 210, the station transmitted signal is received by the receptacle transceiver 116 at the current position of the receptacle (in operation 212). From the strength of the signal a determination is made in operation 214 of whether the receptacle is within a pre-selected threshold of the pre-selected position. An indication of whether the receptacle is at the pre-selected position is generated by the receptacle indicator 122 in accordance with the strength of the signal as in operation 216. Until the receptacle is properly positioned, the station transmission, the receptacle reception, and the receptacle indication operations continue as shown by the repeating loop at operation 218. Of course, if the receptacle does not reach the position within a preselected time, the indication can be discontinued to save power. Once the receptacle reaches its proper position, though, the receptacle may be emptied in operation 220. Tracking information may also be collected and stored in the receptacle memory 118 and read from the receptacle memory 118 as illustrated in operations 222, 224, and 226.

In another preferred embodiment, motion is sensed first and subsequently power is applied to the power consuming components of the system. When the motion stops, power may then be removed. This preferred embodiment provides a low power consumption approach to determining whether the receptacle is at its preselected position.

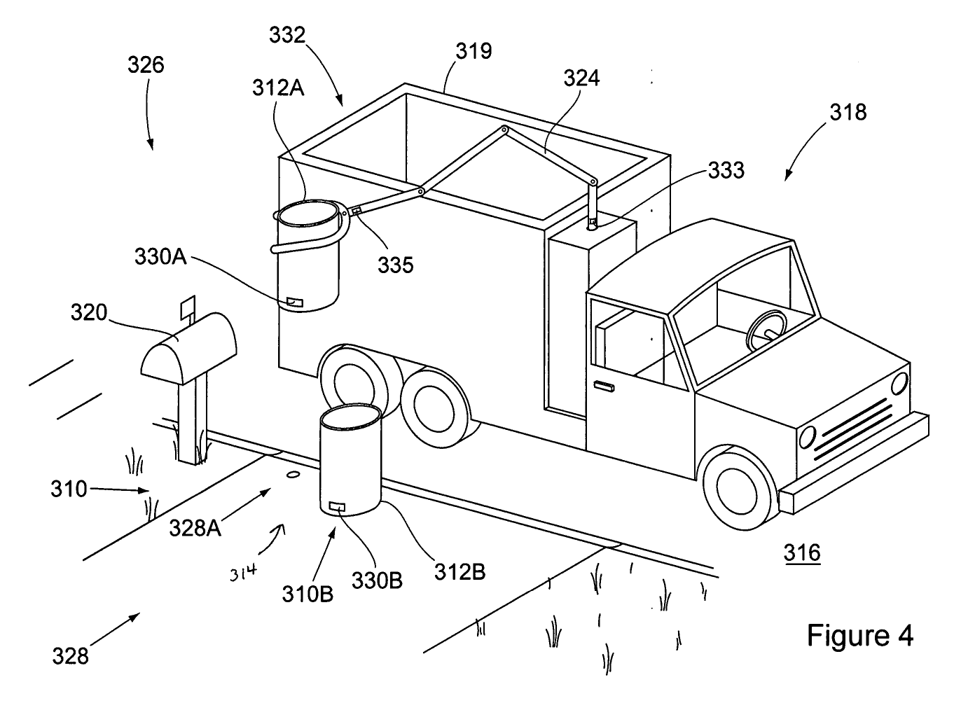

With reference now to FIG. 4, another preferred embodiment of the present invention is illustrated. The system 310 differs from the system 10 (shown in FIG. 1) in that the system 310 is a system for use with residential receptacles 312. More particularly, the truck 318 is a side-loading truck 318 with a multi-degree of freedom articulating arm 324, as opposed to the front-loading truck 18 (of FIG. 1). The receptacle station 314 is typically on the driveway, sidewalk, or lawn of the receptacle user. Of course, the truck area 316 is usually a street, alley, or parking lot (e.g. for apartment based receptacle users). Accordingly, it is preferred to keep the station and receptacle subsystems 328 and 330 (e.g. subsystems 328A and 330A), respectively, simple and inexpensive. Thus, the station sub-system 328 (e.g. subsystem 328A) includes only a transmitter that transmits a periodic pulse along with ancillary components desirable for supporting the transmitter. Also, the receptacle sub-system 330 (e.g. subsystem 330A) includes only a receiver and an indicator for positioning the receptacle 312 based on the periodic pulse (and ancillary components desirable for supporting the receiver and indicator).

When the truck 318 arrives to empty the receptacle(s) 312 it can read the receptacle identifications from the receptacle sub-system(s) 330. The truck sub-system 332 can also verify, from information read from the station sub-system(s) 326, whether the particular receptacle belongs to the particular station 314 (i.e. another receptacle user has not placed a receptacle among the proper user's receptacles). If not, the truck 318 operator can refuse to empty the receptacle or can take other action as suggested by the circumstances. Otherwise, the truck operator proceeds to empty the receptacle(s) 312 using the articulating arm 324.

Whereupon several additional preferred embodiments of the present invention may be employed. For instance, the truck sub-system 332 may include a weight sensor 333 positioned to sense the weight of each receptacle 312. In the alternative, the receptacle sub-system 330 may include a weight sensor to sense the weight of the receptacle. Thus, the present invention enables the truck 318 operator to bill the receptacle 312 user based on weight rather than just the count of how many receptacles 312 have been emptied at the station 314. Further, the truck sub-system 335 can include a motion sensor 335, or lift counter, to determine how many times the operator empties, or attempts to empty, receptacles 312 at a particular station 314. Thus, if a receptacle 312 is routinely out of position, thereby requiring multiple attempts at lifting the receptacle, the truck operator could charge the receptacle user for the additional labor and time necessitated by the improper positioning.

For the purposes of the present invention, it will be understood that phrases such as “an object being at a pre-selected position” means that the object is located in a pre-determined relationship with the pre-selected position. Generally the centering of the object over the pre-selected position is preferred. However, many different pre-determined relationships exist. For instance, a receptacle including a transceiver on one corner could be said to be at the pre-selected position if the transceiver (and therefore corner) is over the pre-selected position. The choice of the pre-selected position and the pre-determined relationship is determined by the receptacle user (or truck operator) taking into account the geometry of the station, the geometry of the receptacle, the capabilities of the transmitter and receiver, and other practical considerations well known to those of ordinary skill in the art. For instance, a system with multiple transmitter/receiver pairs per receptacle (or station) may be employed so that not only is the positioning of the receptacle accomplished with greater accuracy, but the receptacle is also oriented with improved accuracy over that of a single transmitter/receiver pairs.

In view of the foregoing, it will be seen that the several advantages of the invention are achieved and attained. For instance, the invention benefits both receptacle users and truck operators by improving the billing accuracy. More particularly, the present invention facilitates container identification for billing and other data collection purposes. Further, truck operators enjoy greater productivity because the operators need not spend the time to align misaligned receptacles. Additionally, because the operator need not leave the cab of the truck, the operator is not exposed to road (or parking lot) traffic. Further, because the receptacles constructed in accordance with the present invention will be aligned properly, fewer collisions between the receptacle and nearby structures will occur during receptacle handling operations. Also, if the receptacle is employed as a feed source for an automated manufacturing system less spillage and fewer shortages of the feed will result. Likewise, if the receptacles are used to store items, the present invention facilitates proper location and identification of the receptacles and the objects within the receptacles.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A receptacle comprising:
a body for containing articles;
a radio transceiver on the body, transmitting a first radio frequency signal, and for receiving a second radio frequency signal that is responsive to the first radio frequency signal;
an indicator on the receptacle and communicating with the radio transceiver in such a manner that if the second signal is received by the transceiver, the indicator indicates whether the strength of the second signal is indicative of the receptacle being approximately at a pre-selected position for the receptacle; and
a power supply on the receptacle and powering the indicator.

2. The receptacle according to claim 1 further comprising:
a radio frequency identification (RFID) tag reader, the RFID tag reader including the transceiver.

3. The receptacle according to claim 1 further comprising:
a memory communicating with the transceiver and storing tracking data pertinent to the receptacle.

4. The receptacle according to claim 1, further comprising:
a motion sensor on the body and communicating with the indicator in such a manner that the indicator indicates whether the strength of the second signal is indicative of the receptacle being approximately at a pre-selected position for the receptacle when the receptacle is moving.

5. The receptacle according to claim 4, further comprising:
a timing circuit on the receptacle and communicating with the indicator and the motion sensor in such a manner that the indicator turns off a pre-selected time after the receptacle stops moving.

6. A receptacle for receiving articles comprising:
a body including a bottom and a plurality of sides extending from the bottom, the body defining a volume for containing articles; and
a circuit including:
a transmitter for transmitting a signal from the receptacle,
a receiver for receiving a signal responsive to the signal from the receptacle, the responsive signal to be from a pre-selected position for the receptacle, and
an indicator adapted to indicate that the receiver is receiving the responsive signal in a manner indicative of the receptacle being approximately at the pre-selected position.

7. The receptacle according to claim 6, further comprising:
an RFID reader including the transmitter and receiver.

8. The receptacle according to claim 6, the circuit further comprising:
a memory for storing tracking information pertinent to the receptacle.

9. The receptacle according to claim 8, further comprising:
the memory further for communicating the tracking information.

10. The receptacle according to claim 6, further comprising:
a motion sensor communicating with the indicator in such a manner that the indicator indicates whether the strength of the responsive signal is indicative of the receptacle being approximately at the pre-selected position for the receptacle when the receptacle is moving.

11. The receptacle according to claim 6, further comprising:
the indicator being proportionally responsive to the strength of the responsive signal.

12. A station for handling at least one receptacle, the station comprising:
a pre-selected position for the receptacle, the receptacle to include a transmitter, a bottom, and a plurality of sides extending from the bottom, the receptacle to define a volume for containing articles; and
a transceiver at the pre-selected position, the transceiver to respond to a signal to be transmitted by the transmitter and to indicate whether the receptacle is approximately at the pre-selected position.

13. The station according to claim 12, further comprising:
a second pre-selected position for a second receptacle and a second transceiver at the second pre-selected position.

14. The station according to claim 12, further comprising:
an enclosure at the pre-selected position and enclosing the transceiver.

15. The station according to claim 12, further comprising:
the transceiver being below grade

16. The station according to claim 12, further comprising:
the transceiver being an RFID tag.

17. The station according to claim 12, further comprising:
a memory in communication with the transceiver and adapted to store tracking information pertaining to the receptacle.

18. The station according to claim 12, further comprising:
an area for a vehicle to align with the receptacle for handling the receptacle when the receptacle is approximately at the pre-selected position.

19. A method of handling a receptacle, comprising:
pre-selecting a position at which to handle the receptacle;
transmitting a signal from the pre-selected position;
receiving the signal on the receptacle; and
indicating whether the received signal is indicative of the receptacle being approximately at the pre-selected position.

20. The method according to claim 19, further comprising:
placing a transmitter below grade at the pre-selected position, the transmitter transmitting the signal.

21. The method according to claim 19, further comprising:
using an RFID tag to receive the signal.

22. The method according to claim 19 further comprising:
using an RFID tag reader to transmit the signal.

23. The method according to claim 19, further comprising:
sensing movement of the receptacle, the indicating further comprising indicating whether the received signal is indicative of the receptacle being approximately at the pre-selected position and the receptacle is moving.

24. A system for positioning a receptacle, the receptacle including a bottom and a plurality of sides extending from the bottom, the receptacle defining a volume for containing articles and being movable, the system comprising:
a transmitter transmitting a signal, the transmitter being at one of a pre-selected position for the receptacle and on the receptacle;
a receiver to receive the signal, the receiver being at the other of the pre-selected position and on the receptacle; and
an indicator in communication with the receiver and adapted to indicate whether the receiver received the transmitter signal in a manner indicative of the receptacle being at the pre-selected position.

25. The system according to claim 24, further comprising the transmitter being on the receptacle and a motion sensor sensing whether the receptacle is moving and being on the receptacle, the motion sensor communicating with the system in a manner so that the power drawn by the system is minimized when the motion sensor senses that the receptacle is not moving.

26. The system according to claim 24, further comprising the receiver being on the receptacle and a motion sensor sensing whether the receptacle is moving and being on the receptacle, the motion sensor communicating with the receiver in a manner so that the power drawn by the receiver is minimized when the motion sensor senses that the receptacle is not moving.

27. The system according to claim 24, further comprising a memory storing tracking data pertinent to the receptacle and communicating with the one of the transmitter and receiver that is on the receptacle.

28. The system according to claim 27 wherein the tracking data is used to bill an owner of the receptacle

29. A system for positioning a receptacle, the receptacle including a bottom and a plurality of sides extending from the bottom, the receptacle defining a volume for containing articles and being movable, the system comprising:
a transmitter transmitting a signal, the transmitter being at one of a pre-selected position for the receptacle and on the receptacle;
a receiver to receive the signal, the receiver being at the other of the pre-selected position and on the receptacle;
an indicator in communication with the receiver and adapted to indicate whether the receiver received the transmitter signal in a manner indicative of the receptacle being at the pre-selected position; and
a motion sensor sensing whether the receptacle is moving and being on the receptacle, the motion sensor communicating with the one of the transmitter and receiver that is on the receptacle in a manner so that the power drawn by the one of the transmitter and receiver that is on the receptacle is minimized when the motion sensor senses that the receptacle is not moving.

30. A system for positioning a receptacle, the receptacle including a bottom and a plurality of sides extending from the bottom, the receptacle defining a volume for containing articles and being movable, the system comprising:
a transmitter transmitting a signal, the transmitter being at one of a pre-selected position for the receptacle and on the receptacle;
a receiver to receive the signal, the receiver being at the other of the pre-selected position and on the receptacle;
an indicator in communication with the receiver and adapted to indicate whether the receiver received the transmitter signal in a manner indicative of the receptacle being at the pre-selected position; and
a memory storing tracking data pertinent to the receptacle and communicating with the one of the transmitter and receiver that is on the receptacle.

31. A system for positioning a receptacle, the receptacle including a bottom and a plurality of sides extending from the bottom, the receptacle defining a volume for containing articles and being movable, the system comprising:
a transmitter transmitting a signal, the transmitter being at one of a pre-selected position for the receptacle and on the receptacle;
a receiver to receive the signal, the receiver being at the other of the pre-selected position and on the receptacle;
an indicator in communication with the receiver and adapted to indicate whether the receiver received the transmitter signal in a manner indicative of the receptacle being at the pre-selected position; and
a memory storing tracking data pertinent to the receptacle and communicating with one of the transmitter and receiver, whereby the tracking data is used to bill an owner of the receptacle
